(19) United States
(12) Patent Application Publication
(10) Pub. No.: US 2025/0172280 A1
(43) Pub. Date: May 29, 2025

(54) LIGHTING SYSTEM

(71) Applicant: KA SUEN CHAN, HONG KONG (CN)

(72) Inventor: KA SUEN CHAN, HONG KONG (CN)

(21) Appl. No.: 18/790,094

(22) Filed: Jul. 31, 2024

Related U.S. Application Data
(60) Provisional application No. 63/602,510, filed on Nov. 24, 2023.

(51) Int. Cl. F21V 23/00; F21V 17/16; F21V 23/06; F21Y 113/20; F21Y 115/10; H05B 47/155

(52) U.S. Cl. CPC F21V 23/008; F21V 17/162; F21V 23/06; H05B 47/155; F21Y 2113/20; F21Y 2115/10

(57) ABSTRACT

The application discloses a lighting system. The lighting system includes a system bracket extending along a first direction; a plurality of drive units operatively connected to the system bracket independently, such that a distance between any two drive units along the first direction is adjustable; a plurality of lighting units detachably connected to the drive units, and a lighting component consisting by one drive unit and one lighting unit that is connected to the drive unit; wherein an electrical connection is generated between the drive unit and the lighting unit, within each lighting component, and the drive unit is configured to provide an ideal working voltage and/or current for the lighting unit.

### PRIORITY CLAIM

This application claims the benefit of and priority to Provisional Patent Application No. 63/602,510 filed on Nov. 24, 2023 and entitled “ThinkGrow Model One Modular LED Lighting System” which is hereby incorporated by reference in its entirety.

### TECHNICAL FIELD

This application pertains to the field of artificial light source technology, particularly related to a lighting system.

### BACKGROUND

With the continuous advancement of technology, artificial light sources have begun to be widely used in indoor spaces to address lighting issues. However, based on the actual application needs of different space sizes, artificial light sources need to provide different levels of illumination.

Especially in applications involving plant cultivation, it is often necessary to maintain as consistent a level of illumination as possible to ensure that all illuminated objects receive roughly the same amount of light.

However, current lighting devices are usually fixed and can only be set for specific sizes or shapes of areas, such as LED light strips made by LED diodes. These LED strips are rigidly fixed onto specific fixtures or brackets through soldering, adhesive bonding, or integral molding. This rigidity results in these lighting devices being unable to provide consistent levels of illumination across areas of different sizes or geometric shapes.

To address this issue, some lighting devices have been designed with large single surfaces, where LED diodes are set up and installed to form specific diode arrays. By appropriately turning on and off the LEDs within these arrays, the devices can adapt to areas of different sizes or shapes, minimizing differences in illumination levels.

However, this approach still has many flaws and cannot adequately adapt to scenarios with significant differences, still being limited by the size and shape of the single surface.

### SUMMARY

An embodiment of the application discloses a lighting system. The lighting system includes: a system bracket extending along a first direction; a plurality of drive units operatively connected to the system bracket independently, such that a distance between any two drive units along the first direction is adjustable; a plurality of lighting units detachably connected to the drive units, and a lighting component consisting by one drive unit and one lighting unit that is connected to the drive unit; wherein an electrical connection is generated between the drive unit and the lighting unit, within each lighting component, and the drive unit is configured to provide an ideal working voltage and/or current for the lighting unit.

An advantageous aspect of the lighting system according to the application is that it offers multiple independent lighting components. The positions of these lighting components on the system bracket are flexibly adjustable, providing strong adaptability and effectively delivering ideal illumination levels in spaces of any size and dimension. For example, the level of illumination can be enhanced by increasing the number of lighting components and reducing the intervals between them.

### BRIEF DESCRIPTION OF THE DRAWINGS

One or more embodiments are illustratively described with corresponding drawings. These illustrative descriptions do not limit the embodiments. Elements with the same reference numeral in the drawings are represented as similar components. Unless specifically stated, the drawings do not constitute a limitation on proportion.

FIG. 1 is a schematic diagram of the structure of the lighting system according to an embodiment of the application.

FIG. 2 is a schematic diagram of the structure of the lighting component according to the embodiment of the application.

FIG. 3 is a schematic diagram of the structure of the lighting system from another perspective, according to the embodiment of the application.

FIG. 4 is a schematic diagram of the structure of the drive unit according to the embodiment of the application.

### DETAILED DESCRIPTION

The detailed description of this application is provided below in conjunction with specific embodiments. It should be emphasized that the following description is merely illustrative and is not intended to limit the scope of the application or its applications.

It should be noted that unless explicitly defined and limited, the terms “center,” “longitudinal,” “transverse,” “upper,” “lower,” “vertical,” “horizontal,” “inner,” “outer,” and other directional or positional terms used in this specification are based on the directions or positions shown in the attached drawings. These terms are used merely for convenience in describing the application and simplifying the description, and do not imply that the devices or components referred to must have a specific orientation, be constructed and operated in a specific orientation, and thus should not be understood as limiting the application. The terms “mounted,” “connected,” “linked,” “fixed,” etc., should be understood broadly, for example, they could mean permanently connected or detachably connected, or integrally connected; they could be mechanical or electrical connections; they could be directly connected or indirectly connected through an intermediate medium. Moreover, the terms “first,” “second,” etc., are used only for descriptive purposes and should not be construed as indicating or implying relative importance or implicitly indicating the number of technical features indicated; thus, a feature defined as “first,” “second,” may explicitly or implicitly include one or more such features; “multiple” means two or more; “and/or” includes any and all combinations of one or more of the related listed items. For those skilled in the art, the specific meanings of these terms in this application can be understood based on the circumstances.

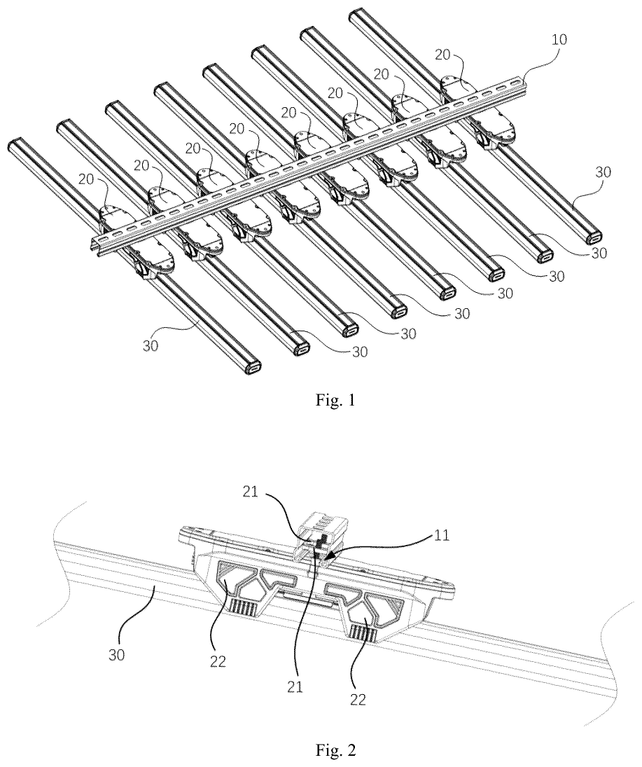

FIG. 1 is a schematic structural diagram of the lighting system according to an embodiment. As shown in FIG. 1, the lighting system includes a system bracket 10, drive units 20 and lighting units 30.

The system bracket 10 is a structural component used for support. It provides the basic structure of the lighting system and can be chosen to use any appropriate type of size or material according to the needs of the actual situation. An exemplary elongated system bracket is shown in FIG. 1, which extends in a first direction with a predetermined length. The predetermined length can be determined according to the needs of the actual situation, such as the size of the lighting area, etc.

A lighting component that can emit light outward is composed of one drive unit 20 and one lighting unit 30. The lighting unit 30 is detachably fixedly connected with the drive unit 20. There also exists an electrical connection between the drive unit 20 and the lighting unit 30, whereby the drive unit 20 is used to provide the required working voltage and/or working current to the lighting unit 30 to emit light outward.

The term “detachably fixedly connected” means that the lighting unit 30 fixed on the drive unit 20 can be detached from the drive unit 20 as needed.

Please refer to FIG. 1, each drive unit 20 is independently operatively connected to the system bracket 10. The term “operatively connected” describes a connection method between two structural components that has a variable state. In other words, the drive unit 20 has two states: remaining relatively stationary with respect to the system bracket 10 and moving freely relative to the system bracket 20.

Specifically, the position of the drive unit 20 on the system bracket 10 is adjustable.

In some embodiments, in addition to being independently mechanically connected to the system bracket 10, each drive unit 20 is also independently connected to external device through independent cables, thereby ensuring that each lighting component has independent control capabilities.

The external device is electronic equipment that cooperates and supports the normal operation and working of the lighting system. For example, a power supply providing electrical energy to the lighting system and a control system providing control information to control one or more lighting components to operate in an expected state (e.g., expected brightness).

In practical use, when the size and shape of the usage area change, the spacing between different lighting components in the first direction can be adjusted by simply changing the position of the drive unit 20 on the system bracket 10 to maintain consistent light levels.

For example, when the size of the usage area increases and a higher level of light consistency is required, the spacing between the lighting components can be reduced to bring them closer together, thereby enhancing the light level. Conversely, when the size of the usage area decreases, the spacing between the lighting components can be increased to reduce the light level.

Alternatively, it is also possible to concentrate more lighting components in some sections of the system bracket while removing lighting components from other sections, since the usage area is in an irregular shape.

The “operatively connected” can be achieved through various different means. Exemplarily, FIG. 2 shows a scenario where the system bracket 10 and the drive unit 20 are operatively connected through a guiding mechanism.

As shown in FIG. 2, the system bracket 10 is provided with a guide rail 11 extending along the first direction. Correspondingly, the drive unit 20 is provided with at least one guide rail sliders 21.

The guide rail slider 21 is accommodated within the guide rail 11. The guide rail 11 and the guide rail sliders 21 have matching dimensions, thus forming a guiding mechanism to guide the reciprocal movement of the drive unit 20 along the first direction.

Specifically, please refer to FIG. 2, for better guidance and support, the guide rail slider 21 may be set up in pairs.

These two guide rail sliders 21 are symmetrically positioned on both sides of the drive unit 20 along the length direction of the drive unit, providing balanced and stable support for the drive unit 20 and preventing any unwanted oscillation.

In some embodiments, the drive unit 20 and the lighting unit 30 are detachably connected via a snap-fit structure. This snap-fit structure greatly facilitates the installation and removal of the lighting unit 30, eliminating the need for maintenance personnel to use specific tools.

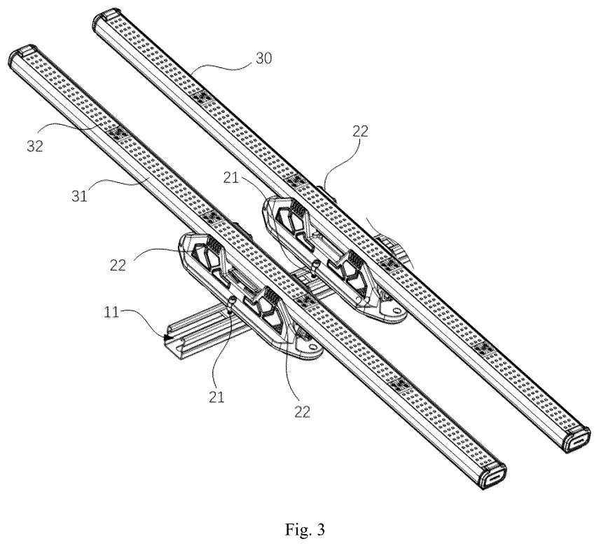

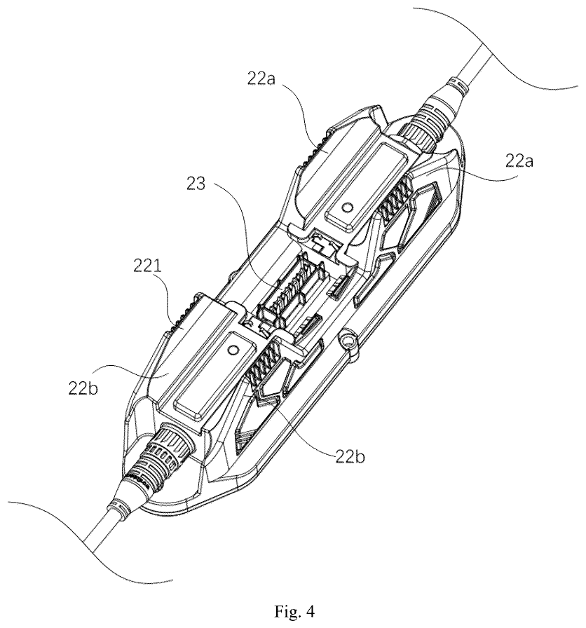

As shown in FIG. 3, the elongated drive unit 20 is provided with a locking component 22. The locking component 22 forms a housing space that can accommodate at least a part of the lighting unit 30.

The housing space has dimensions and shapes that are compatible with the outer contour of the lighting unit 30. It is arranged along the length direction of the drive unit, thus positioning the lighting unit 30 fixed on the drive unit 20 along its length direction.

For the sake of simplicity, the “second direction” is used hereafter to denote the length direction of the drive unit. The second direction is perpendicular to the first direction on the plane where the drive unit is located.

Specifically, please refer to FIG. 3, the lighting unit 30 is an LED light fixture with a preset length. The LED light fixture includes a light fixture body 31 of specified length and multiple LED diodes 32 set on the light fixture body.

The light fixture body 31 is bar shaped. When the lighting unit 30 is fixed on the drive unit 20 along the second direction, the lighting unit 30 is approximately forming a 90-degree angle with the system bracket.

In practical use, the locking component 22 has a certain degree of elastic deformability. The lighting unit 30 can deform the locking component 22 by pressing under an external force, thus entering the housing space. After the lighting unit 30 enters the housing space, the locking component 22 returns to its original shape, confining the lighting unit 30 within the housing space and securing it on the drive unit 20.

In some embodiments, as shown in FIG. 3, the guide rail sliders 21 and the locking components 22 can be respectively set on two opposing surfaces of the drive unit 20. This arrangement allows the lighting unit 30 to be suspended and fixed under the system bracket 10 without being obscured by other structures, and also avoids affecting the movement of the drive unit 20.

For the sake of simplicity, the “first surface” and “second surface” are used below to denote the two opposing surfaces of the drive unit 20. Specifically, the first surface is the surface of the drive unit 20 facing towards the system bracket.

The guide rail slider 21 is located on the first surface, while the locking component 22 extends outward from the second surface, cooperating with at least a part of the second surface to form a housing space.

In some embodiments, the locking component 22 of the drive unit 20 consists of an even number of claps, ensuring the balanced force on the lighting unit 30, allowing it to be stably and reliably fixed to the drive unit 20.

FIG. 4 shows a scenario with four claps. As shown in FIG. 4, a pair of claps 22a are symmetrically set on both sides of the drive unit along the first direction; another pair of claps 22b are spaced a preset distance apart in the second direction. Thus, the four claps are provided with four support points for the lighting unit 30, enabling it to be stably and reliably fixed.

Both clap types 22a and 22b adopt similar or identical structures. For instance, the clap generally appears as flat pieces extending outward from the second surface, forming a protruding part 221 at the end of the extension.

Once the lighting unit 30 is fully housed, the protruding part 221 can abut against the lighting unit 30 to prevent it from slipping out of the housing space. The protruding part 221 may also feature structures like inclined contact surfaces to facilitate the displacement of the protruding part 221 when the lighting unit 30 is being inserted.

The electrical connection between the drive unit 20 and the lighting unit 30 can be achieved through various methods. In some embodiments, the electrical connection between the drive unit 20 and the lighting unit 30 can be established through physical contact between electrical contacts.

Such a connection based on physical contact of electrical points is simple and reliable, better meeting the operational needs of the lighting unit 30.

Please refer to FIG. 4, where the drive unit 20 has an electrical connector 23 on the second surface facing the housing space.

The electrical connector 23 consists of several pins, arranged and configured in a specific manner. For example, as shown in FIG. 4, multiple pins are arranged linearly along the second direction.

In practical use, when the lighting unit 30 is housed and fixed within the housing space, a corresponding receptacle of the lighting unit 30 can establish a tight and reliable physical contact with the electrical connector 23, thereby establishing an electrical connection between the drive unit 20 and the lighting unit 30.

Preferably, the lighting unit 30 has hot-plugging capability. “Hot plugging” refers to the ability to safely insert or remove electronic equipment without turning off the system power or interrupting system operation. The lighting unit 30 with hot-plugging capability provides high availability and maintenance flexibility.

In some embodiments, the lighting system includes at least two different types of light fixtures to accommodate different practical usage needs. The “type of LED fixture” refers to the type of LED diodes integrated within the LED fixtures. In other words, different types of LED fixtures are integrated with different types of the LED diodes, which can provide various lighting characteristics or levels.

During actual usage, the LED fixtures mounted on each drive unit can be conveniently replaced to meet different usage needs, and various types of LED fixtures can be used together, in the lighting system.

When the lighting system according to this embodiment is placed and fixed in needed locations through a system bracket, it can flexibly adjust the positional relationships between different lighting components to change the lighting levels (for example, bringing lighting components closer together to provide higher light levels, or spacing them further apart to provide lower light levels).

In addition, each lighting component in the lighting system consists of an independent drive unit and a lighting unit. Each drive unit is also independently connected to external devices. The lighting unit and the drive unit can be combined at will and can be easily installed and removed. This provides a high degree of flexibility and a variety of combination options, which can well meet and adapt to the needs of different scenarios.

The above content is a further detailed explanation of this application in conjunction with specific/preferred embodiments and should not be construed as limiting the specific implementations to these descriptions. For those skilled in the art, several modifications and improvements can be made without departing from the concept of this application, and these are within the scope of protection of this application.

What is claimed is:

1. A lighting system, comprising:
a system bracket extending along a first direction;
a plurality of drive units operatively connected to the system bracket independently, such that a distance between any two drive units along the first direction is adjustable;
a plurality of lighting units detachably connected to the drive units, and a lighting component consisting by one drive unit and one lighting unit that is connected to the drive unit;
wherein an electrical connection is generated between the drive unit and the lighting unit, within each lighting component, and the drive unit is configured to provide an ideal working voltage and/or current for the lighting unit.

2. The lighting system according to claim 1, wherein the system bracket is provided with a guide rail extending along the first direction; the drive unit comprises a guide rail slider compatible with the guide rail;
wherein the guide rail slider cooperates with the guide rail to form a guiding mechanism for guiding the drive unit to move along the first direction.

3. The lighting system according to claim 2, wherein the drive unit comprises two guide rail sliders, that are symmetrically arranged on both sides of the drive unit along a length direction of the drive unit.

4. The lighting system according to claim 3, wherein the drive unit further comprises a locking component, and a receiving space for accommodating at least a part of the lighting unit is formed by the locking component;
wherein the receiving space is arranged along a second direction; the second direction is the length direction of the drive unit.

5. The lighting system according to claim 4, wherein the lighting unit is an LED light fixture with a preset length and the second direction is perpendicular to the first direction.

6. The lighting system according to claim 3, wherein the guide rail sliders are arranged on a first surface of the drive unit, and the locking part extends outward from the second surface of the drive unit and cooperates with at least part of a second surface to form the receiving space;
wherein the first surface and the second surface are opposed to each other, and the first surface faces the system bracket.

7. The lighting system according to claim 6, wherein the second surface is provided with an electrical connector facing the receiving space;
wherein the lighting unit is electrically connected to the drive unit through physical contact with the electrical connector.

8. The lighting system according to claim 6, wherein the locking component comprises at least four clasps;
wherein a pair of clasps are symmetrically arranged on both sides of the drive unit along the first direction; adjacent pairs of clasps are spaced a predetermined distance in the second direction, and
each clasp is extend outward from the second surface, and a protruding part is formed at the end of the extension and configured to restrict the lighting unit from escaping from the receiving space by abutting against the lighting unit.

9. The lighting system according to claim 5, wherein the LED light fixture comprises a light fixture body of a preset length and a plurality of LED diodes arranged on the light fixture body.

10. The lighting system according to claim 8, wherein the lighting units comprises at least two different types of LED light fixtures, each containing different types of the LED diodes.

11. The lighting system according to claim 1, wherein each drive unit is connected to an external device via an independent cable, and the external devices comprises a power supply and a control system.

12. The lighting system according to claim 1, wherein the lighting unit has hot-plugging capability.
